(19) United States
(12) Patent Application Publication
(10) Pub. No.: US 2016/0283356 A1
(43) Pub. Date: Sep. 29, 2016

(54) EVENT-DRIVEN AUTOMATION TESTING FOR MOBILE DEVICES

(71) Applicant: HEWLETT PACKARD ENTERPRISE DEVELOPMENT LP, Houston, TX (US)

(72) Inventors: Dori Waldman, Yehud (IL); Lior Reuven, Yehud (IL); Ameer Tabony, Yehud (IL); Eyal Luzon, Yehud (IL)

(21) Appl. No.: 15/035,071

(22) PCT Filed: Nov. 18, 2013
(86) PCT No.: PCT/US2013/070588

§ 371 Date: May 6, 2016

(51) Int. Cl. G06F 11/36

(52) U.S. Cl. CPC G06F 11/3664; G06F 11/3684; G06F 11/3688

(57) ABSTRACT

Example embodiments relate to automation testing for mobile devices. Instructions executable by a processor of a mobile device may include test policy receiving instructions to receive a test policy from a test server. The test policy may be created or configured by a user of the test server. The instructions executable by the processor may include event listening instructions to detect an event of the mobile device. The event may be defined in the test policy. The instructions executable by the processor may include test initiating instruction to cause an automation test to run on the mobile device when the event is detected. The automation test and its association with the event may both defined in the test policy.

### BACKGROUND

In software testing, automation testing is the use of software to control the execution of tests, for example, on a computing device, and the analysis of actual outcomes of those tests. Mobile application testing is a process by which application software, or simply an application, developed for mobile devices is tested for its functionality, usability and consistency on mobile devices. Mobile applications may either come pre-installed on mobile devices or they can be installed from an application distribution platform.

### BRIEF DESCRIPTION OF THE DRAWINGS

The following detailed description references the drawings, wherein:

FIG. 1 is a block diagram of an example computing environment in which event-driven automation testing for mobile devices may be useful;

FIG. 2 is a flowchart of an example method for event-driven automation testing for mobile devices;

FIG. 3 is a block diagram of an example mobile device for event-driven automation testing;

FIG. 4 is a flowchart of an example method for event-driven automation testing for mobile devices; and

FIG. 5 is a block diagram of an example system for event-driven automation testing for mobile devices.

### DETAILED DESCRIPTION

Achieving high quality mobile application testing results may be challenging for various reasons, for example, because of device compatibility issues. Mobile applications can be deployed across devices provided by various different manufacturers. Additionally, mobile applications may be installed on devices that run various operating systems and operating system versions. Furthermore, even on a particular device running a particular operating system, a mobile application may behave differently in different runtime environments. For example, a mobile device may be running at a particular battery level, at a particular CPU utilization, or with other applications running concurrently. Additionally, a mobile device may run mobile applications at different geographic locations, during different movement patterns (e.g., walking, driving, etc.), with different localization information, on different carrier networks, or with different levels of network traffic.

Thus, it is important to receive mobile application testing results from real mobile devices being used in real-world situations. Some methods of testing mobile applications may test mobile devices in a lab with simulated use scenarios. In a lab, it may be difficult to receive mobile application testing results from a wide enough variety of mobile devices and based on a wide enough variety of use cases. Other methods of testing mobile applications may employ human testers with real mobile devices, but these testers (e.g., beta testers) manually test the mobile application by using the mobile application in various use cases. For these testing methods, the testers manually run through a list of use scenarios or conjure up various use scenarios in order to fulfill their testing obligations. Thus, this may be considered a “passive” testing method from the viewpoint of a mobile application developer because the developer merely trusts that the tester will provide good usage data, and the application developer has limited input into what kinds of tests or usage scenarios are employed.

The present disclosure describes event-driven automation testing for mobile devices. The present disclosure describes automated mobile testing that may be performed transparently on real mobile devices of real users that may be using their devices in real world situations. Not only does the present disclosure describe automatic mobile testing that may be performed on various mobile devices and operating systems, but the automatic mobile testing may be tailored to collect usage information in various operation and usage situations. According to the present disclosure, a mobile agent that transparently runs on a mobile device may be configured to listen for various events and the mobile agent may initiate automation tests when these events are detected. The mobile agent may detect various types of events such as device operation or state scenarios, user interaction scenarios, scheduling or timing conditions or the like. The mobile agent may receive test policies from a test server where the test policies are configured by an administrator or user of the test server. For example, the administrator of the test server may be a mobile application developer. The test polices may specify the various events that the mobile agent is to listen for and the tests that are to be initiated based on the events.

The present disclosure allows mobile application developers, for example, to gain more control over how their applications are tested (e.g., what kinds of tests or usage scenarios are employed). The present disclosure describes automation testing that reduces or eliminates the need for choices or input by a human tester. As such, the testing described herein may be performed on real devices in real world usage situations instead of being performed in a lab. Because the mobile agent may run transparently on the mobile device, users may use their devices as they normally would on a day to day basis, which may provide rich, interesting usage tests. Overall, this allows for improved testing of mobile applications which leads to higher quality mobile applications. Additionally, because a test server administrator may quickly define and deploy new tests that will be run automatically on various devices in real use, testing may be performed more quickly. This may be especially useful in the era of “BYOD” (bring your own device), where administrators in a work environment, for example, may be forced to support a larger, more diverse and constantly changing set of devices.

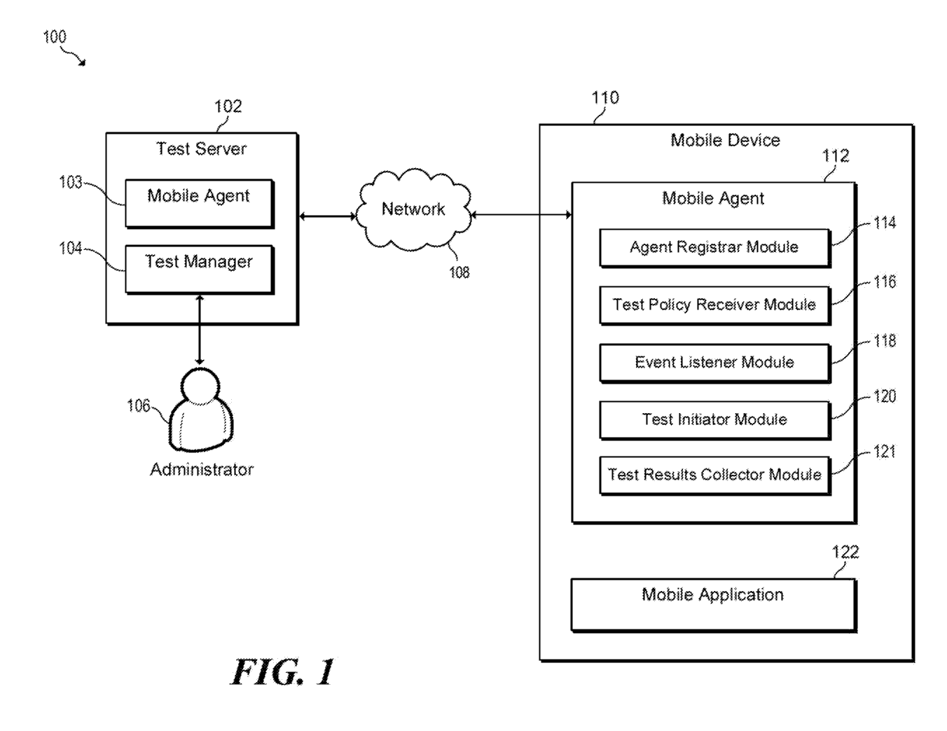

FIG. 1 is a block diagram of an example computing environment 100 in which event-driven automation testing for mobile devices may be useful. Computing environment 100 may include a test server 102 and at least one mobile device (e.g., 110). It should be understood that although FIG. 1 and various descriptions herein may indicate only a single mobile device (e.g., 110), more than one mobile device may be in communication with test server 102, and more than one mobile device may include a mobile agent that operates in a manner similar to mobile agent 112. Each mobile device may be in communication with test server 102 via a network (e.g., 108). Network 108 may be any wireless network, and may include any number of hubs, routers, switches or the like. Network 108 may be, for example, part of the internet, at least one intranet and/or other type(s) of network(s).

An administrator 106 (or simply referred to as a “user”) may interact with test server 102, for example, to control which tests may be run on mobile devices (e.g., 110) and when. It may be useful to describe some example user scenarios with regard to FIG. 1. In one example, administrator 106 may be a mobile application developer, and may wish to have a mobile application tested. The application developer may interact with test server 102 (e.g., with test manager 104) to define which tests should be run. Test server 102 may then interact with a mobile agent (e.g., 112) on a mobile device (e.g., 110) to instruct the mobile device how to run in order to test the application. The test server 102 may also instruct the mobile device to install the application to be tested. Test results may then be returned to the application developer (e.g., 106) by way of the mobile device communicating with the test server (e.g., with test manager 104). In another example, administrator 106 may be an enterprise manager (e.g., an IT manager) that desires to ensure that various mobile devices (e.g., 110) work with the various software and network products used by the enterprise. In this example, the manager (e.g., 106) may interact with the test server to define various tests that should be run on mobile devices (e.g., mobile devices used by the enterprise). In each of the examples described above, the administrator 106 may specify which devices (e.g., 110) should be able to communicate with test server 102 to receive indications of tests to be run, to return results and the like. For example, an enterprise manager may only wish for its own employees to run the tests. Various details of how a mobile device may register with the test server may be described in more detail below.

Test server 102 may include test manager 104 and a mobile agent 103, e.g., for download by at least one mobile device (e.g., 110). Test server 102 may communicate with the at least one mobile device (e.g., 110) via network 108. For example, test server 102 may indicate tests that should be run and may receive test results from at least one mobile device (e.g., 110). Test server 102 may be at least one computing device that is capable of communicating with a mobile device (e.g., 110) over a network (e.g., 108). In some embodiments of the present disclosure, test server 102 may include more than one computing device. In other words, the components shown in test server 102 (e.g., test manager 104, mobile agent 103, etc.) in FIG. 1 may be, but need not be, distributed across multiple computing devices, for example, computing devices that are in communication with each other via a network. In these embodiments, the computing devices may be separate devices, perhaps geographically separate. Thus, the term “system” may be used to refer to a single computing device or multiple computing devices that operate together to provide a service. As one specific example, a system may include one computing device that includes test manager 104 and another computing device that includes mobile agent 103 for download by mobile devices.

Mobile agent 103 may be similar to mobile agent 112 described below. In some examples, mobile agent 103 may be a version of mobile agent 112 in a format that is a download package of sorts. Then, mobile device (e.g., 110) may download and install mobile agent 103. Then, the mobile device may execute the installed mobile agent, which may be similar to mobile agent 112, which may be in a more executable format. Mobile agent 103 may include a series of instructions encoded on a machine-readable storage medium of test server 102.

Test manager 104 may allow an administrator 106 or user to interact with test server 102. For example, test manager 104 may include a user interface or GUI (graphical user interface). Test manager 104 may allow the administrator to define and configure various events (e.g., mobile device operation or state scenarios, user interaction scenarios, scheduling or timing conditions, etc.) and related automation tests. Test manager 104 may allow the administrator to define a number of rules, where, each rule indicates a number of automation tests that are to run when a particular event is detected or when a combination of events is detected. Such specified events and associated automation tests may be referred to collectively as one or more test policies. A test policy may include these components and perhaps various other pieces of information that a mobile device may reference for testing. More details regarding test policies, detection of events and running of automation tests based on detection of events may be described below, for example, with regard to the event listener module 118 of mobile agent 112 of FIG. 1.

Test manager 104 may also allow the administrator to determine which mobile devices should be allowed to receive test polices and/or run tests based on the test policies. As may be described in more detail below, a mobile device (e.g., 110) may run a mobile agent (e.g., 112) to listen for various events (e.g., device operation or state scenarios, user interaction scenarios, scheduling or timing conditions, etc.) and to run tests in response. The mobile agent may have to register with test server 102 (e.g., with test manager 104) before it may run fully on a mobile device. Via test manager 104, the administrator may enter a list, range, group, type (or the like) of devices that are authorized. The mobile agent (e.g., 112) may then communicate with test manager 104 to receive authorization. In this respect, an application developer, enterprise manager or the like may limit the testing of its application or devices to appropriate users (e.g., employees of the enterprise manager). This feature, along with the ability of the administrator to define various tests and various events that dictate when the tests run gives the administrator flexibility and control over testing (e.g., which user base, how tested, how intensively tested, priority of tests). This provides benefits over beta testing where beta testers test applications more or less however they see fit. Thus, administrators can gain more control over test flow and get better test results.

Test manager 104 may receive test results from various mobile devices (e.g., 110) based on automation tests run in accordance with test policies defined via test manager 104. Test manager 104 may save, log and/or categorize (e.g., by device type, event type, time, etc.) results. Test manager 104 may perform (e.g., automatically upon receipt of test results) analytics, routines, calculations or the like on various tests or groups of tests, perhaps across multiple mobile devices. The output of such analytics, routines, calculations or the like may be referred to as analytical results. Test manager 104 may allow an administrator (e.g., 106) to view (e.g., via a GUI) test results, for example, test results in raw form or analytical results, e.g., based on numerous tests. Test manager 104 may also determine that issues or problems exist (e.g., with a mobile device or mobile application) based on the test results, and test manager 104 may allow an administrator to view such issues or problems. For example, an administrator may be able to see that a particular version of an operating system does not run a particular application without error. Then, the administrator may be able to investigate whether the issue or problem is due to the particular application or with the mobile device (e.g., a glitch in the mobile device operating system version). More details regarding test results that may be generated by a mobile device and received by test manager 104 may be described below, for example, with regard to the test initiator module 120 and/or test results collector module 121 of mobile agent 112 of FIG. 1.

Test manager 104 may include one or more hardware devices including electronic circuitry for implementing the functionality described below. Test manager 104 may additionally include a series of instructions encoded on a machine-readable storage medium and executable by the one or more hardware devices of test manager 104.

Mobile device 110 may be any computing device that is capable of communicating with test server 102 over a network (e.g., 108). For example, mobile device 110 may receive test polices from test server 102 and may send test results back to test server 102 after performing at least one test based on the test policies. Mobile device 110 may be any computing device that may be carried by a user and is operational for the user without being tied down to a particular location (e.g., a desk or rack). For example, mobile device 110 may be a laptop, smart phone, tablet, smart watch, PDA or the like. As such mobile device 110 may include a battery to allow for operation without being plugged into a power source (e.g., a wall power source). It should be understood, however, that in some situations, mobile device 110 may be plugged into a power source and/or may be stationary. Mobile device 110 may also include various sensors that allow for various functionalities related to the mobile device's mobile or cordless nature, for example, a GPS sensor/antenna, a WiFi antenna, RFID sensor, proximity sensor, motion sensor (e.g., accelerometer), etc. Mobile device 110 is just one example of a mobile device that may be in communication with test server 102. Various other mobile devices may be in communication with test server 102 and may include components similar to the components of mobile device 110 as described in more detail below. In the example of FIG. 1, mobile device 110 includes a mobile agent 112 and at least one mobile application 122.

Mobile application 122 may be an application that is to be tested by mobile device 110. Mobile application 122 may have come pre-installed on mobile device 110, or mobile device 110 may have downloaded mobile application 122 from a server, e.g., over a network (e.g., such as 108). Determining the functionality of mobile application 122 may be the primary purpose of the testing described herein, for example, if administrator 106 is an application developer. In other examples, mobile application 122 may be run (e.g., along with other applications) to test the functionality of the mobile device 110 itself (e.g., the device hardware, operating system, operating system version, etc.). In some examples, if mobile application 122 has to be run for certain tests, the user of mobile device 110 may be instructed to download mobile application. In other examples, mobile agent 112, when run on mobile device 110, may automatically download and install mobile application 122 as part of running the mobile agent or as part of running a particular test indicated by or included in mobile agent 112.

Mobile agent 112 may detect various events (e.g., device operation or state scenarios, user interaction scenarios, scheduling or timing conditions, etc.) defined in the test policies, and may initiate automation tests based on these detection of these events. Mobile agent 112 may already come installed on mobile device 110, or the user of mobile device 110 may download mobile agent 112 from a server (e.g., mobile agent 103 from test server 102). In other examples, the server from which the mobile agent (e.g., 103) is downloaded may be a different computing device than the computing device that runs test manager 104. As one specific example, a user of mobile device 110 may be provided with a download link or URL, and may download the mobile agent using the link or URL. As another example, mobile device 110 may automatically download the mobile agent, e.g., in response to a signal or “push” from test manager 104. In some examples, if mobile agent 112 is downloaded automatically, a user may have an option to opt out of automatic downloads.

Mobile agent 112 may, in some situations, run continuously and transparently on mobile device 110, which means mobile agent 112 may be running on the operating system of the mobile device 110, but may present limited or no information to the user that indicates that the mobile agent 112 is running. This may benefit the user because mobile agent 112 may not interfere with the user's regular use of mobile device 110. This may also benefit the application developer, enterprise manager and the like that is in charge of testing because the test results may be based on real world unobstructed usage by the user, and the tests may run on the mobile device while the user makes real use of the user's device. In situations where mobile agent 112 may run transparently, the user of mobile device 110 may have the option to select an option to receive indications, authorization message or the like when mobile agent 112 is running or is about to run various tasks.

Mobile agent 112 may include a series of instructions encoded on a machine-readable storage medium (e.g., 420 of FIG. 4) and executable by a processor (e.g., 410) of a mobile device (e.g., 400 or 110). In addition or as an alternative, mobile agent 112 may include one or more hardware devices including electronic circuitry for implementing the functionality described below. Mobile agent 112 may include a number of modules (e.g., 114, 116, 118, 120, 121). Each of these modules may include a series of instructions encoded on a machine-readable storage medium (e.g., 420 of FIG. 4) and executable by a processor (e.g., 410) of a mobile device (e.g., 400 or 110). In addition or as an alternative, each module may include one or more hardware devices including electronic circuitry for implementing the functionality described below. With respect to the modules described and shown herein, it should be understood that part or all of the executable instructions and/or electronic circuitry included within one module may, in alternate embodiments, be included in a different module shown in the figures or in a different module not shown.

Agent Registrar Module 114 may allow mobile agent 112 to register with test server 102 (e.g., with test manager 104) before mobile agent 112 may run fully on a mobile device 110. Mobile agent (e.g., 112) may communicate with test manager 104 to receive authorization. Registration may be important in various situations, for example, with testing of sensitive applications such as bank applications. In some situations, a user of mobile device 110 may enter an identification or authentication number or code. Agent registrar module may allow for entering of such a number or code, may send the number/code to test manager 104, and may receive back an authentication or denial.

Test policy receiver module 116 may receive test policies from test server 102 (e.g., from test manger 104). The test policies may define various mobile device events (e.g., device operation or state scenarios, user interaction scenarios, scheduling or timing conditions, etc.) and automation tests (e.g., tests associated with device events). The test policies may include a number of rules, where, each rule indicates a number of automation tests that are to run when a particular event is detected by mobile agent 112 or when a combination of events is detected. In some examples, test policy receiver module 116 may receive or retrieve test policies automatically without input from the user of mobile device 110. For example, new test polices may be “pushed” to mobile device 110 when they are newly created by test manager 104. Then, the listening for events (e.g., by module 118) and running tests (e.g., by module 120) based on the new test polices my also automatically begin when a new test policy is received. In some examples, a test policy may indicate a particular mobile application (e.g., 122) to be downloaded and installed (e.g., automatically) in order for certain tests to take place.

Event Listener Module 118 may listen for various events that may trigger various automation tests to be run. Thus, it may be said that the automation testing performed by mobile agent 112 is “event driven.” An “event” may be any device operation or state scenario, user interaction scenario, scheduling or timing condition or the like, and the events that module 118 is to listen for may be defined in the test policies received from test server 102. When event listener module 118 detects a particular event, mobile agent 112 may then initiate (e.g., via module 120) at least one automation test (e.g., on demand or on-the-fly) that is related to the event according to the test policies. Event Listener Module 118 may listen for events related to the operation or state of mobile device 110, such as battery level (high, low, etc.), GPS activity (starting GPS, signal lost, etc.), CPU activity (high, low, etc.), WiFi activity (signal detected, signal lost, etc.) and localization changes. Event Listener Module 118 may listen for various other device operation or device state events as well, for example, whether mobile device 110 is near a point of sale device (POS) such as an ATM, vending machine or the like. As another example, module 118 may monitor various sensors (e.g., accelerometer, GPS, etc.) of mobile device 110 to determine if the mobile device is moving and the type of motion (e.g., driving, on a train, walking, etc.). Event Listener Module 118 may also listen for various user interactions with mobile device 110, for example, a user enabling the GPS, speaking to the mobile device (voice recognition), etc.

Event Listener Module 118 may also listen for various scheduling, time and/or calendar events, for example, a particular day of the week, time of day, etc. Some scheduling events may be reoccurring. A particular scheduling event may also be referred to as a scheduling condition (e.g., Mondays at 3:45 pm). When event listener module 118 detects a particular event, mobile agent 112 may then initiate (e.g., via module 120) at least one automation test (e.g., on demand or on-the-fly) that is related to the scheduling event according to the test policies.

Test Initiator Module 120 may automatically run or initiate the running of various automation tests based on indications from event listener module 118 (e.g., indications that various events were detected, as described above). The tests that test initiator module 120 runs based on various events may be defined in the test policies. Because test imitator module 120 may automatically run tests without user input, the human factor required for many beta testing methods may be reduced or eliminated. Thus, for application developers for example, instead of hoping that a beta tester will test an application in a useful manner, the application developer may take more control over the testing. Moreover, because test initiator module 120 may, based on the test policies, imitate tests once useful events are detected, test results may be generated in response to useful, natural real world events.

Test initiator module 120 may run various types of tests. As one example, test imitator module 120 may run a particular mobile application (e.g., 122). Such a mobile application, as described above, may need to be downloaded on mobile device 110 before such a test may be run. Mobile application 122 may be downloaded and installed automatically, for example, when mobile application 112 is installed, or when new test policies are received by module 116. As another example, mobile application 122 may be downloaded and installed as part of a test initiated by module 120. Thus, a particular test may download the application required for the test, install the application and then run appropriate tests.

Test initiator module 120 may run various tests that run in the background of mobile device 110, for example, as a background process that runs on an operating system of mobile device 110. Example background tests may include connecting to a remote database, opening a network connection or the like. These background tests may require not user interaction, and may run transparently (e.g., the user sees no indication of the test on the screen of their mobile device) as to not interfere with the user's usual activity. In fact, by not interfering with the user, the user may use their device more like they normally would, thereby providing more interesting interactions, scenarios and more useful test results. Test initiator module 120 may run background tests in response to event listener module 118 detecting a usage scenario (e.g., low battery, CPU usage high, etc.) or in response to a scheduling condition (e.g., every day at 13:00).

Test initiator module 120 may run various user interface (UI) type tests. Such tests may include scripts that essentially simulate various user interface interactions on mobile device 110. For example, a mobile application may be launched and various screens of the application may be navigated through, and various buttons, links and tabs of the mobile application GUI may be selected, e.g., in a logical usage flow. Such user interface tests may have an impact on the user of the mobile device because such tests may affect what displays on the screen of the mobile device for example. Thus, such tests may be imitated at strategic times in order to reduce the impact on the user. If, however, such tests require user input, the test may cause a notification message to be displayed on the mobile device 110.

To reduce the impact on the user, UI tests may be run when the mobile device is idle (i.e., not in use). For example, test initiator module 120 may determine that mobile device 110 is idle, and may then wake up the mobile device and run the UI test. If, for some reason, the mobile device ceases to be idle (e.g., a user picks up the mobile device) during a UI test, test imitator module 120 may stop the ongoing test and restart or resume later when the mobile device is again idle. In order to determine if the mobile device is idle, module 120 may check various indicators of the mobile device, for example, whether the time of day is a logical time for inactivity (e.g., at night), whether the screen is on/off, various sensors for lack of motion (e.g., GPS, accelerometer, etc.), proximity sensors to determine whether the user's hand is close, whether the mobile device is receiving any incoming events (e.g., phone call, SMS), whether the mobile phone is running any other background processes.

Test initiator module 120 may also simulate various mobile device states in order to create a more interesting testing environment. For example, once an event is detected causing a test to run, module 120 may “add” additional device state conditions (e.g., simulated device rotation, etc.).

Test initiator module 120 may include a timeout functionality whereby particular tests may expire if they are not run within a defined period of time. The defined period of time may be specified in the test policies. Timeouts may occur for various reasons. For example, a particular test policy may specify that a test should be run in response to a particular user input (e.g., turning on WiFi), but that user input may not occur for a long period of time. A timed-out test may be treated in a similar manner to a completed test in that testing environment data may be collected (e.g., by module 121), and the results of the test (e.g., timeout) may be sent to the test server 102 (e.g., by module 121).

Test results collector module 121 may receive, organize and save (e.g., as local logs, perhaps temporarily) information that is pertinent to various tests initiated by module 120. The automation tests initiated by module 120 may produce various types of information that may be useful for analysis, e.g., by an application developer. For example, for background tests, the information may include what event triggered the test, what test was run as a result, whether the test succeeded or failed, and any process or error logs generated by the mobile device (e.g., the operating system of the mobile device) as a result of the test. For UI tests, similar information may be collected. In addition, for UI tests, the information may include the mobile device state, the screen state (e.g., a flow or progression of screen shots), related simulated or actual user actions (e.g., in relation to the screen shots). By collecting information about user actions in relation to screen shots, a developer, for example, may ensure that the application looks and flows (e.g., from screen to screen) as it was intended to on the mobile device, and the developer may determine which screen was displayed on the device when a particular error or other event occurred.

Test results collector module 121 may receive various pieces of environmental or device state data related to various automation tests. Such pieces of information may indicate what was happening on the mobile device during the automation test. For example, module 121 may receive data such as battery level, CPU usage, localization information, location according to GPS, other processes that were running on the mobile device, and the like. Such information may allow an application developer, for example, to build a complete picture of the runtime environment at the time a particular test was run.

Test results collector module 121 may send test results to test server 102, or to some other server. For example, test results collector module 121 may send test results to test manager 104. Test manager 104 may perform at least one automatic analysis routine on the received test results. Test manager 104 may notify (e.g., by email, or pop-up notification) administrator 106 that test results have been received. Such a notification may be sent on a per-test result basis or after a batch of test results have been received. Once test results are received, administrator 106 may interact with test manager 104 to view the test results and perhaps to perform further analysis on the tests results, for example, by manual analysis or by initiating analyses routines.

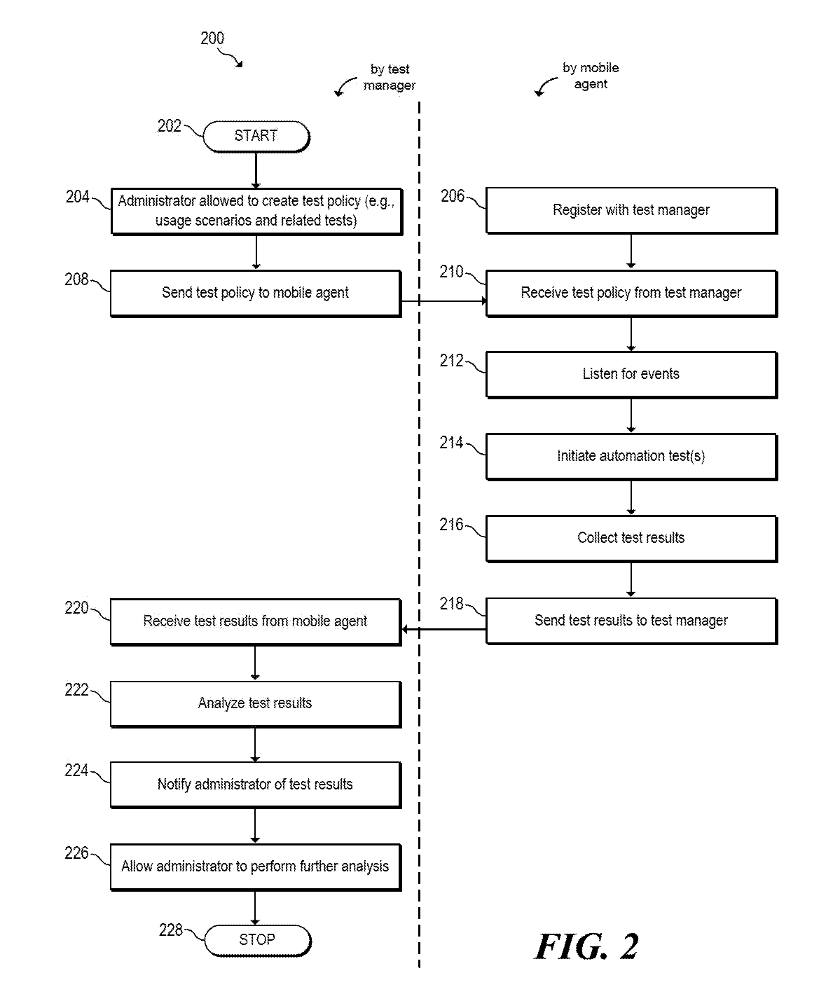

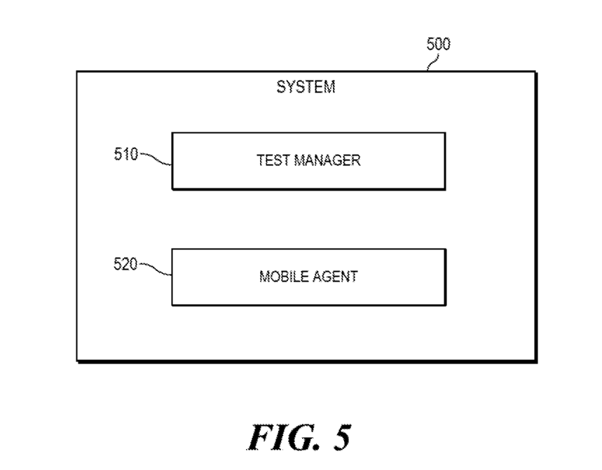

FIG. 2 is a flowchart of an example method 200 for event-driven automation testing for mobile devices. The execution of method 200 is described below with reference to a test manager (e.g., similar to test manager 104 of test server 102 of FIG. 1) and a mobile agent (e.g., similar to mobile agent 112 or mobile agent 103 of FIG. 1). Various other suitable computing devices may execute part or all of method 200, for example, mobile device 400 of FIG. 4 or system 500 of FIG. 5. Method 200 may be implemented in the form of executable instructions stored on at least one machine-readable storage medium, such as storage medium 420, and/or in the form of electronic circuitry. In alternate embodiments of the present disclosure, one or more steps of method 200 may be executed substantially concurrently or in a different order than shown in FIG. 2. In alternate embodiments of the present disclosure, method 200 may include more or less steps than are shown in FIG. 2. In some embodiments, one or more of the steps of method 200 may, at certain times, be ongoing and/or may repeat. For example, steps 212, 214, 216, 218 and 220 may repeat, be ongoing or may loop in order to listen for various types of events and run and report tests based on those events.

Method 200 may start at step 202 and may continue to step 204. Method 200 may alternatively proceed from step 202 to step 206 or step 204 and step 206 may occur concurrently. At step 204, a test manager (e.g., 104) run on a test server (e.g., 102) may allow an administrator (e.g., 106) to create a test policy (e.g., various usage scenarios, user interactions, scheduling conditions and related automation tests). At step 206, a mobile agent (e.g., 112 or 103) may be capable of registering (e.g., via module 114) with the test server. The mobile agent (e.g., 112) may have been downloaded an installed by a mobile device and may be running on on the mobile device or the mobile agent (e.g., 103) may be in the form of executable instructions ready for download on a server, for example, the test server or another server. At step 208, the test manager may send the test policy to the mobile agent. At step 210, the mobile agent may be capable of receiving (e.g., via module 116) the test policy from the test manager. At step 212, the mobile agent may be capable of listening (e.g., via module 118) for events (e.g., usage scenarios, scheduling conditions, etc.). At step 214, the mobile agent may be capable of imitating (e.g., via module 120) at least one automation test, e.g., based on at least one of the events being detected.

At step 216, the mobile agent may be capable of collecting (e.g., via module 121) test results, e.g., from the test(s) run at step 214. At step 218, the mobile agent may be capable of sending the test results to the test manager. At step 220, the test manager may receive the test results from the mobile agent. At step 222, the test manager may analyze the test results, e.g., automatically without administrator input. At step 224, the test manager may notify the administrator that the test results were received and/or that a test is complete. At step 226, the test manager may allow the administrator to perform further analysis of the test results. Method 200 may eventually continue to step 228, where method 200 may stop.

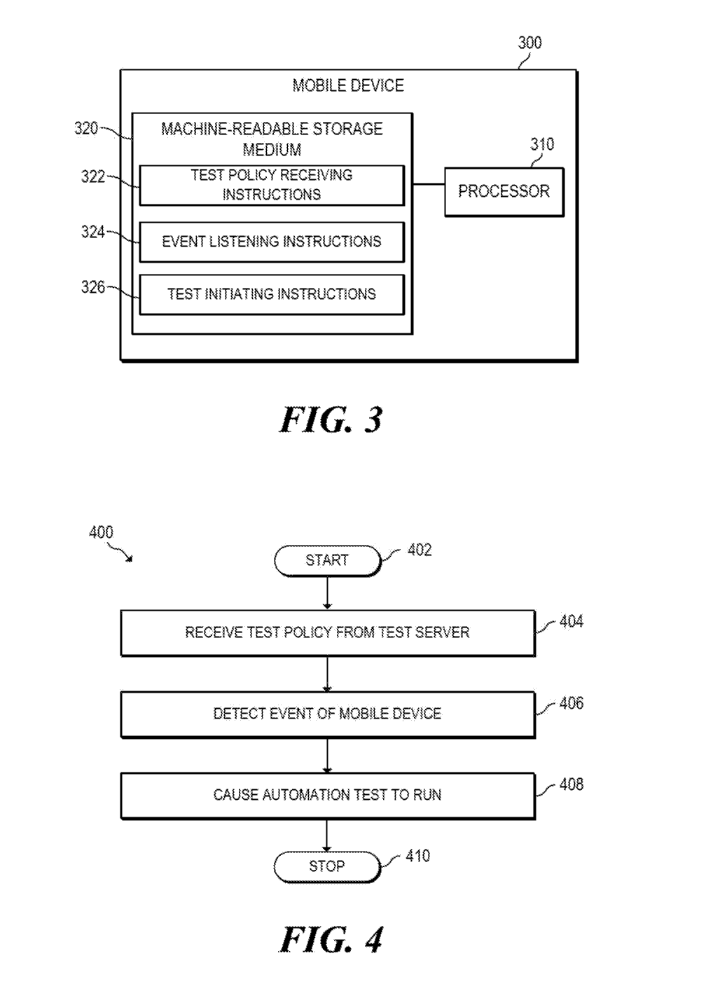

FIG. 3 is a block diagram of an example mobile device 300 for event-driven automation testing. Mobile device 300 may be similar to mobile device 110 of FIG. 1, for example. Mobile device 300 may be any computing device that is capable of communicating with a test server (e.g., 102) over a network. In the embodiment of FIG. 3, mobile device 300 includes a processor 310 and a machine-readable storage medium 320.

Processor 310 may be one or more central processing units (CPUs), microprocessors, and/or other hardware devices suitable for retrieval and execution of instructions stored in machine-readable storage medium 320. In the particular embodiment shown in FIG. 3, processor 310 may fetch, decode, and execute instructions 322, 324, 326 to facilitate event-driven automation testing. As an alternative or in addition to retrieving and executing instructions, processor 310 may include one or more electronic circuits comprising a number of electronic components for performing the functionality of one or more of instructions in machine-readable storage medium 320. With respect to the executable instruction representations (e.g., boxes) described and shown herein, it should be understood that part or all of the executable instructions and/or electronic circuits included within one box may, in alternate embodiments, be included in a different box shown in the figures or in a different box not shown.

Machine-readable storage medium 320 may be any electronic, magnetic, optical, or other physical storage device that stores executable instructions. Thus, machine-readable storage medium 320 may be, for example, Random Access Memory (RAM), an Electrically-Erasable Programmable Read-Only Memory (EEPROM), a storage drive, an optical disc, and the like. Machine-readable storage medium 320 may be disposed within mobile device 300, as shown in FIG. 3. In this situation, the executable instructions may be “installed” on the mobile device 300. Alternatively, machine-readable storage medium 320 may be a portable, external or remote storage medium (e.g., a storage medium of test server 102), for example, that allows mobile device 300 to download the instructions from the storage medium. In this situation, the executable instructions may be part of an “installation package”. As described herein, machine-readable storage medium 320 may be encoded with executable instructions for event-driven automation testing.

Referring to FIG. 3, test policy receiving instructions 322, when executed by a processor (e.g., 310), may receive a test policy from a test server. The test policy may be created or configured by a user of the test server. Event listening instructions 324, when executed by a processor, may detect an event of the mobile device. The event may be defined in the test policy. The event may be one of the following: a device operation or state scenario, a user interaction scenario, and a scheduling or timing condition. Test initiating instructions 326, when executed by a processor, may cause an automation test to run on the mobile device when the event is detected. The automation test and its association with the event may both be defined in the test policy.

FIG. 4 is a flowchart of an example method 400 for event-driven automation testing for mobile devices. Method 400 may be described below as being executed or performed by a mobile device, for example, mobile device 300 of FIG. 3. Other suitable computing devices may be used as well, for example, mobile device 110 of FIG. 1. Method 400 may be implemented in the form of executable instructions stored on at least one machine-readable storage medium (e.g., 320) of the mobile device, and/or in the form of electronic circuitry. In alternate embodiments of the present disclosure, one or more steps of method 400 may be executed substantially concurrently or in a different order than shown in FIG. 4. In alternate embodiments of the present disclosure, method 400 may include more or less steps than are shown in FIG. 4. In some embodiments, one or more of the steps of method 400 may, at certain times, be ongoing and/or may repeat.

Method 400 may start at step 402 and continue to step 404, where a mobile device (e.g., 300) may receive a test policy from a test server. The test policy may be created or configured by a user of the test server. At step 406, the mobile device may detect an event of the mobile device. The event may be defined in the test policy. The event may be one of the following: a device operation or state scenario, a user interaction scenario, and a scheduling or timing condition. At step 408, the mobile device may cause an automation test to run on the mobile device when the event is detected. The automation test and its association with the event may both be defined in the test policy. Method 400 may eventually continue to step 410, where method 400 may stop.

FIG. 5 is a block diagram of an example system 500 for event-driven automation testing for mobile devices. System 500 may be similar to test server 102 of FIG. 1, for example. System 500 may include any number of computing devices, e.g., computing devices that are capable of communicating with at least one mobile device over a network. In the embodiment of FIG. 5, system 500 includes a test manager 510 and a mobile agent 520 that is capable of being executed by and/or ready for download by at least one mobile device. Test manager 510 may generate a test policy based on input from a user. The test policy may include a mobile device event and an automation test associated with the mobile device event. Mobile agent 520 may be capable of automatically retrieving or receiving the test policy and initiating the automation test when the mobile device event is detected.

1. A machine-readable storage medium encoded with instructions for event-driven automation testing, the instructions executable by a processor of a mobile device, the instructions comprising:
test policy receiving instructions to receive a test policy from a test server, wherein the test policy is created or configured by a user of the test server;
event listening instructions to detect an event of the mobile device, wherein the event is defined in the test policy; and
test initiating instruction to cause an automation test to run on the mobile device when the event is detected, wherein the automation test and its association with the event are both defined in the test policy.

2. The machine-readable storage medium of claim 1, wherein the event is one of the following:
a device operation or state scenario;
a user interaction scenario; and
a scheduling or timing condition.

3. The machine-readable storage medium of claim 2, wherein the device operation or state scenario relates to at least one of the following:
battery level; GPS activity; CPU activity; WiFi activity; proximity of the mobile device to a point of sale device; and motion by the mobile device.

4. The machine-readable storage medium of claim 1, wherein the automation test is one of the following:
a background test that runs transparently on the mobile device; and
a user interface test that tests the flow of screens that are displayed on the mobile device and input entered to the mobile device during at least one of those screens, wherein the input is entered by one of the following:
an automated routine that is part of the automation test; and
a user of the mobile device.

5. The machine-readable storage medium of claim 1, wherein the automation test causes a mobile application to run on the mobile device to test the functionality of the mobile application.

6. The machine-readable storage medium of claim 5, wherein the test policy specifies the mobile application to be tested, and wherein the machine-readable storage medium further comprises instructions to cause automatic downloading of the mobile application prior to causing an automation test to run.

7. The machine-readable storage medium of claim 1, wherein the receiving of the test policy from the test server is performed automatically without input from a user of the mobile device.

8. The machine-readable storage medium of claim 7, wherein the automatic receiving of the test policy is performed in response to the user of the test server creating or modifying the test policy at the test server.

9. The machine-readable storage medium of claim 1, further comprising instructions to send test results to the test server based on the automation test.

10. A method executed on a mobile device for event-driven automation testing, the method comprising:
receiving a test policy from a test server, wherein the test policy is created or configured by a user of the test server;
detecting an event of the mobile device, wherein the event is defined in the test policy, and wherein the event is one of the following: a device operation or state scenario, a user interaction scenario, and a scheduling or timing condition; and
causing an automation test to run on the mobile device when the event is detected, wherein the automation test and its association with the event are both defined in the test policy.

11. The method claim 10, further comprising registering the mobile device with the test server, wherein the registration allows for the receipt of the test policy.

12. A system for event-driven automation testing, the method comprising:
a test manager to generate a test policy based on input from a user, wherein the test policy includes a mobile device event and an automation test associated with the mobile device event; and
a mobile agent executable by mobile device, wherein the mobile agent is capable of automatically retrieving or receiving the test policy and initiating the automation test when the mobile device event is detected.

13. A system of claim of claim 12, wherein the test manager is further to receive test results from the mobile agent, wherein the test results are based on the automation test.

14. A system of claim of claim 12, wherein the test manager is further to automatically perform an analytics routine on the test results once received from the mobile agent.

15. A system of claim of claim 12, wherein the test manager is further to allow the user to specify a number of mobile devices that are authorized to receive the test policy and/or authorized to run the automation test.
